(19) United States
(12) Patent Application Publication
(10) Pub. No.: US 2004/0198260 A1
(43) Pub. Date: Oct. 7, 2004

(54) UWB communication system with shaped signal spectrum

(76) Inventors: Andreas Molisch, North Plainfield, NJ (US); Giovanni Vannucci, Red Bank, NJ (US)

Correspondence Address: Patent Department, Mitsubishi Electric Research Laboratories, Inc., 201 Broadway, Cambridge, MA, 02139, US

(21) Appl. No.: 10/364,220

(22) Filed: Feb. 11, 2003

(51) Int. Cl. H04B 1/04

(52) U.S. Cl. 455/114.1; 455/91

(57) ABSTRACT

In an ultra wide bandwidth communications system a spreading waveform is generated in a transmitter. The spreading waveform is shaped according to shape data, which specifies desirable and undesirable frequency ranges. The shaped spreading waveform is combined with source data and fed to a voltage controlled oscillator for modulation. The combined modulation signal is then transmitted to a receiver so that a spectrum of the transmitted signal has a predetermined shape.

### FIELD OF THE INVENTION

This invention relates generally to wireless communications, and more particularly to shaping the spectrum of transmitted signals in ultra wide bandwidth communication systems.

### BACKGROUND OF THE INVENTION

With the release of the “First Report and Order,” Feb. 14, 2002, by the Federal Communications Commission (FCC), interest in ultra wide bandwidth (UWB) communication systems has increased.

FIG. 1 shows the basic structure of a prior art UWB system 100 including a transmitter 110 and a receiver 120. The main components of the transmitter 110 include a data source 111, which can perform source and channel coding, a CPU 101 for generating pseudo random numbers for a spreading waveform 112, and a transmit voltage controlled oscillator (VCO) 113.

User data, from the data source 111, are added 114 to the spreading waveform 112. This produces a sequence of voltages that are in a range [Vₘᵢₙ+d, Vₘₐₓ−d], where +/−d is the output of the data source 111, and Vₘᵢₙ and Vₘₐₓ are the minimum and maximum voltages in the spreading waveform 112. Thus, the transmitted signal 130 is spread over the UWB spectrum.

A receiver 120 includes means 127 for generating a despreading waveform 122 for a receive VCO 123. The despreading waveform 122 is multiplied 124 with the received signal, and fed into a detector 125. The despreading waveform 122 is identical to the spreading waveform 112, so the output to the data sink 121 is equal to the source data 111, apart from a possible on/off switching, distorted by noise and channel dispersion. This method is a combination of fast frequency hopping with frequency shift keying (FSK).

In part, UWB is intended for low-cost, high data-rate devices. The IEFE 802.15.3a standards group has defined performance requirements for the use of UWB in short range indoor communication system. After error correction and any other overhead, received data rates of at least 110 Mbps at 10 meters are required. This means that the transmission data rate must be greater.

Furthermore, a bit rate of at least 200 Mbps is required at four meters. Scalability to rates in excess of 480 Mbps is desirable, even when the rates can only be achieved at smaller ranges.

A number of techniques are known for spreading the bandwidth of a wireless signal over a large frequency range. Most notable among those are time-hopped impulse radio (TH-IR) and direct-sequence spreading (DSS). These techniques are effectively equivalent when optimum modulation and multiple-access schemes are employed.

One important requirements for UWB systems include fulfillment of the FCC requirements for emissions. This pertains both to a mask in the frequency domain, but also to peak power limits for the emitted signal. The average power limits over all useable frequencies are different for indoor and outdoor systems. These limits are given in the form of the power spectral density (PSD) mask. In the frequency band from 3.1 GHz to 10.6 GHz, the PSD is limited to −41.25 dBm/MHz. The limits on the PSD must be fulfilled for each possible 1 MHz band, but not necessarily for smaller bandwidths.

For systems operating above 960 MHz, there is a limit on the peak emission level contained within a 50 MHz bandwidth centered on the frequency, f_{M}, at which the highest radiated emission occurs. The FCC has adopted a peak limit based on a sliding scale dependent on an actual resolution bandwidth (RBW) employed in the measurement. A system as described in FIG. 1 has a constant-envelope emission, so that the average power is equal to the peak power. In contrast to impulse-radio based systems, limits on the peak emission level are not a concern in this scheme.

It is also desired to provide robust performance in multi-path environments. For many proposed modulation schemes, only performance in additive white Gaussian noise (AWGN) and flat-fading channels have been assessed. This is insufficient in practice, because the coherence bandwidth of UWB channels is typically 100 MHz, and thus much smaller than the system bandwidth, which is between 500 MHz and 10 GHz. Furthermore, there is a possibility that additional constraints will be imposed on the spectrum. Most UWB devices will operate under unlicensed “Part 15” FCC rules, which require the devices to tolerate any interference they may receive, but also forces the devices not to cause interference to licensed users.

In the UWB environment, there are many other potential sources of radio emissions. The most significant will be 802.11a or HIPERLAN 2 cards for wireless LANs in the 5 GHz range. It must also be noted that 2.45 GHz radiation from microwave ovens and 1.8 GHz radiation from wireless telephones may influence a UWB receiver, although these are outside the “official” bandwidth. Likewise, emissions from UWB devices should not interfere with 802.11a cards or wireless telephones. Thus, it is desirable to have a UWB system where both the transmitted and received spectrum can be dynamically adjusted in response to environmental conditions.

It is desired to desired to provide a UWB system that is compliant with regulatory agencies, and industry standards.

### SUMMARY OF THE INVENTION

The invention provides a UWB system that fulfills the above criteria and performs well in multi-path environments. The system can be used to ideally shape of the spectrum of the emitted signal so that it is compliant with regulatory constraints.

In an ultra wide bandwidth communications system a spreading waveform is generated in a transmitter. The spreading waveform is shaped according to shape data, which specifies desirable and undesirable frequency ranges.

The shaped spreading waveform is combined with source data and fed to a voltage controlled oscillator for modulation. The combined modulation signal is then transmitted to a receiver so that a spectrum of the transmitted signal has a predetermined shape.

In one embodiment of the invention, the spreading and despreading waveforms are identical. In another embodiment, the received signal is equalized first to have a constant amplitude envelope, and a different despreading waveform can be used. In another embodiment, the received signal is not equalized, but still a despreading waveform different from the spreading waveform is used.

In another embodiment, the source data is split over multiple substreams, and a different spreading waveform is used for each substream. In addition, both the original and delayed versions of transmitted symbols can be detected to maximize the energy in detected signals.

### BRIEF DESCRIPTION OF THE DRAWINGS

FIG. 1 is a block diagram of a prior art UWB system;

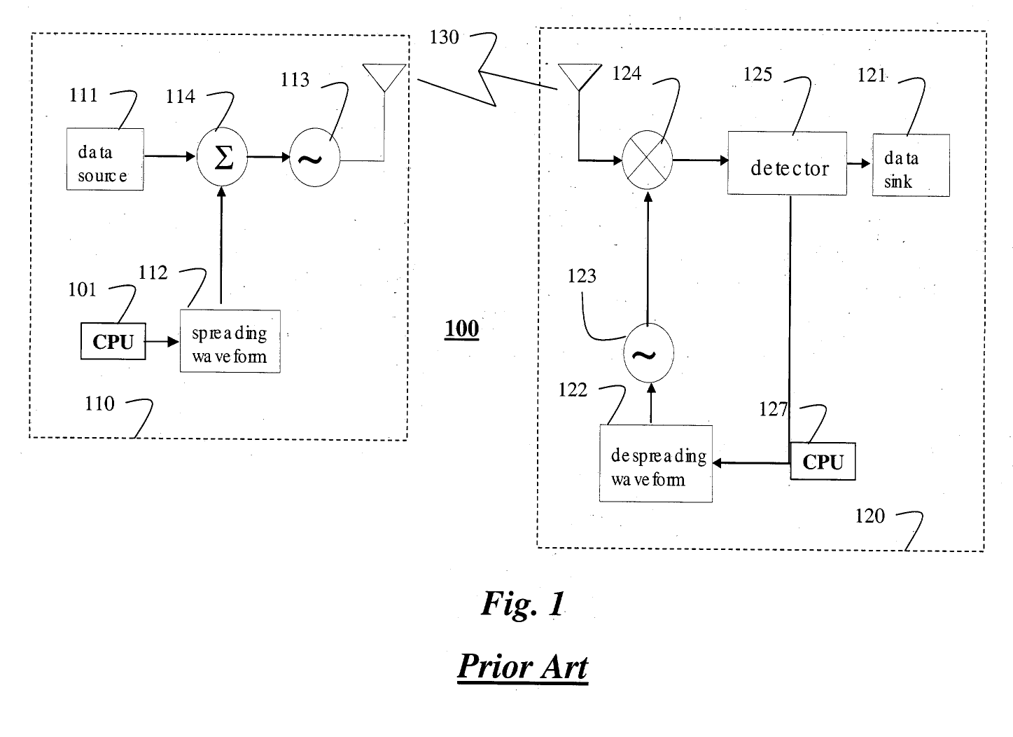

FIG. 2 is a block diagram of a UWB system according to the invention;

FIG. 3 is a block diagram of the UWB system according to the invention with equalization;

FIGS. 4 is a block diagram of the UWB transmitter with frequency subdivision according to the invention; and

FIG. 5 is a block diagram of a UWB receiver with delayed detection of transmitted symbols.

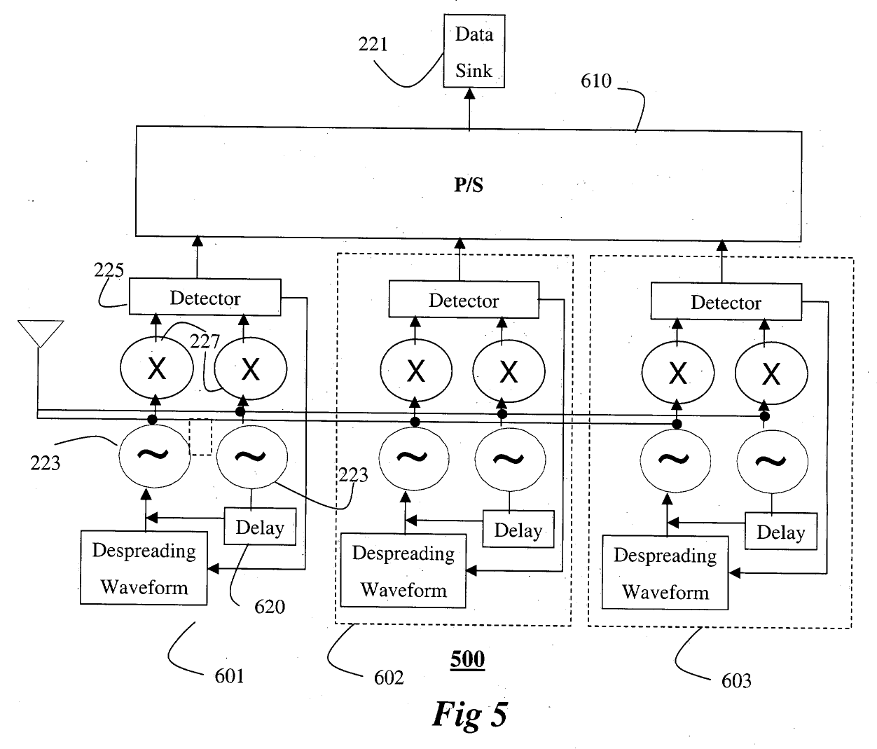

### DETAILED DESCRIPTION OF THE PREFERRED EMBODIMENT

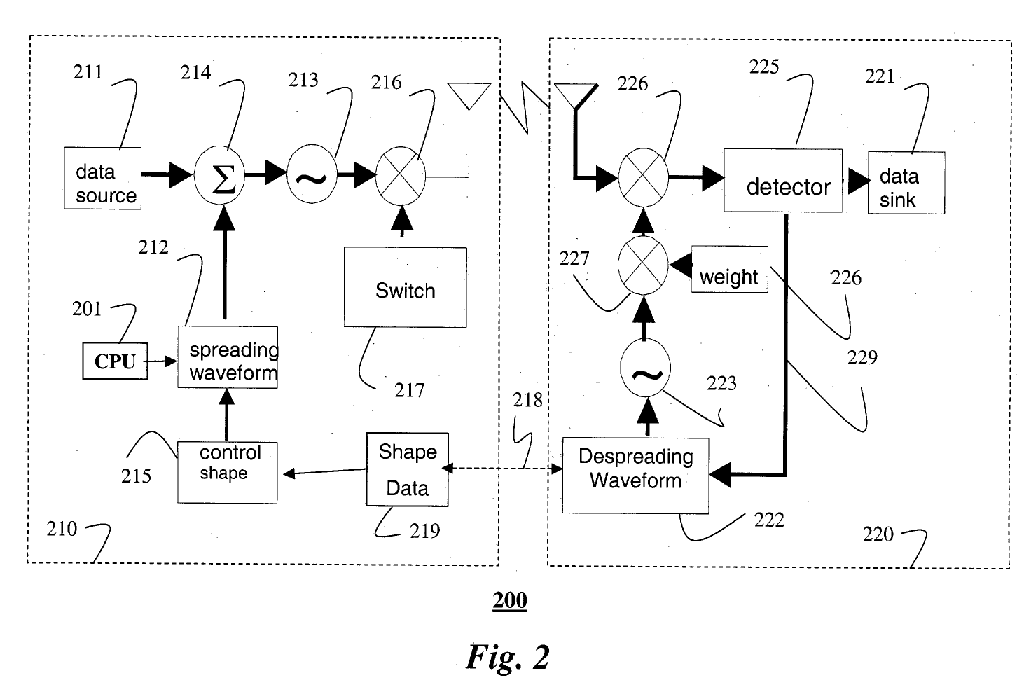

FIG. 2 shows a ultra wide band (UWB) system and method 200 that shapes a spreading waveform according to the invention. By shaping the waveform of the transmit spectrum, the amount of transmitted interference is reduced, and less interference is received from other sources. The shaping can be based on measured or a priori information.

System Structure

A transmitter 210 of the system 200 includes a data source 211, means (CPU) 201 for generating a spreading waveform 212, a voltage controlled oscillator 213, and an adder 214. A shape control 215 shapes the waveform 212, and a multiplier 216 is controlled by a switch 217.

A receiver 220 includes a data sink 211, means for generating despreading waveform generator 222, a VCO 223, first and second multipliers 226-227, and a detector 225. Weights 228 are provided to a second multiplier 227. The weights further modify the despreading signal after modulation.

In most practical UWB systems, the system 200 is arranged in the form of a transceiver that includes both the transmitter 210 and the receiver 220. Thus, the transceiver can exchange information with other likewise configured transceivers.

System Operation

Predetermined Spectral Shaping

The shaping 215 of the spreading waveform 212 is an essential part of the method according to the invention. A first requirement is to have the spectrum of the output signal comply with the FCC spectral mask. This means that the output frequency of the VCO must be between 3.1 GHz and 10.6 GHz. This frequency range is predetermined. Furthermore, certain frequencies are especially sensitive to interference from other systems, and where other systems are sensitive to UWB transmitters.

Therefore, the shape control 215 avoids voltages that would lead the VCO 213 to output signals at those frequencies. One example of an especially critical frequency range is 5.2-5.3 GHz, where IEEE 802.11a wireless LAN systems are to operate.

Measured Spectral Shaping

Because most UWB devices will include both a transmitter and a receiver, it is also possible to measure a received signal in the receiver 220 to determine the properties of noise and interference at the receiver, e.g., using the detector 225. Based on this information, certain frequency regions can be avoided for transmission, by inhibiting the corresponding voltage outputs of the spreading waveform generator 212. Noise and interference can be determined either from a single instantaneous measurement, or by averaging measurements over a period of time.

The measured information can be used to determine the shape of the despreading waveform in the receiver 220, and also fed back 218 to the transmitter 210 and stored as shape data 219; along with predetermined information, such as the 5.2-5.3 GHz frequency range. The shape data 219 can be in the form of desirable and undesirable frequency ranges. The shape controller 215 then uses the shape data 219 to shape the spreading waveform 212.

The feed back 218 can be from a receiver of another transceiver, in the form of shape control messages transmitted by the other transceiver, or the feed back can be from the local receiver.

Channel-Sounding Spectral Shaping

The system can also include a “channel sounder.” This is accomplished by using the multiplier 216 and switch 217 in the transmitter 210 to transmit short sounding pulses, or other appropriate sounding signals from the transmitter to the receiver. The receiver uses the sounding signals to measure a channel transfer function. Then, the spectral shaping 215 can avoid frequency ranges where the channel transfer function has low absolute magnitude, and the receiver despreads accordingly.

The information about the transfer function can be combined with knowledge of the interference. This enables optimization of the signal to interference and noise ratio (SINR). As above, the information can be instantaneous or averaged over a period of time. Averaging over the channel state can lead to a considerable loss of performance, as channels tend to be frequency-flat or show only a weak dependence on frequency, (f²), when averaged over small-scale fading.

Training Sequence Spectral Shaping

The receiver 220 can also receive a training sequence, which automatically contains interference. Thus, the receiver obtains knowledge of the SINR, and the “channel sounder” is not required. This knowledge of the training sequence can be used at the receiver, where the reception of strongly disturbed frequencies' is avoided. If there is sufficient redundancy in the system, then this is better than actually receiving the noise and interference. Furthermore, the shape of the transmit signal can be modified appropriately when information about the SNR of the received signal is sent to the transmitter in the feedback loop 218. $$$ Molisch to Curint: I did not understand that paragraph $$$

Equalization

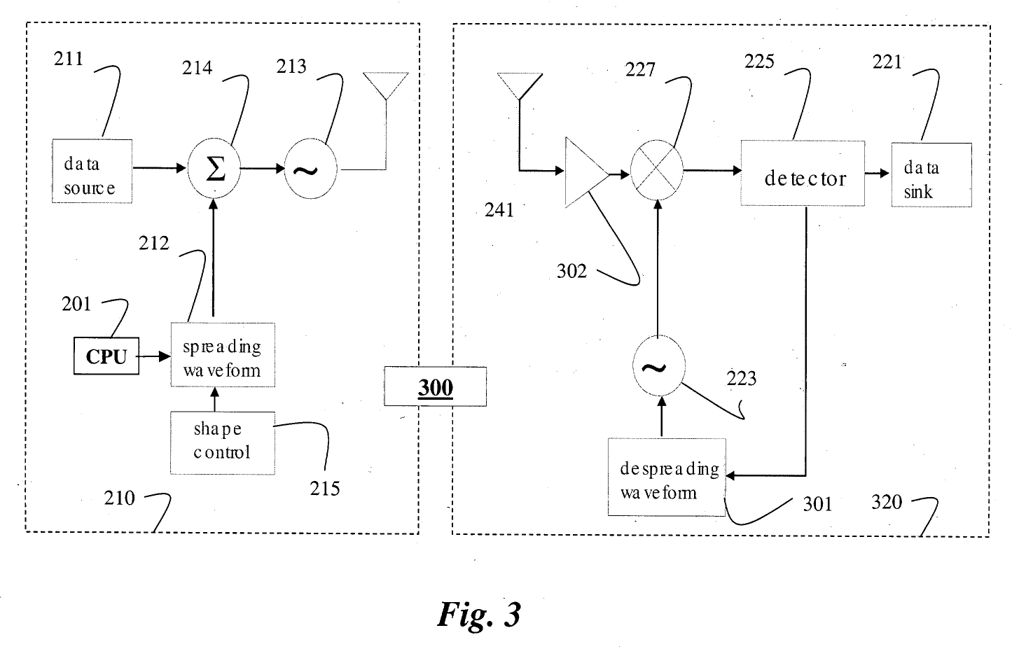

In this method 300, as shown in FIG. 3, the despreading waveform 301 is different from the spreading waveform 212 to compensate for channel distortion. The compensation is accomplished, in part, by an equalizer 302. The equalizer is configured as an amplifier that operates in saturation mode. This enforces the same constant amplitude envelope for the received signal as exists for the transmitted signal.

The equalizer 302 compensates for any amplitude fluctuations induced by the channel on the constant envelope of the transmitted signal. The fluctuations can lead to AM/PM conversion, and further phase distortion of the received signal. These occur in addition to the phase distortion introduced by the channel.

During the transmission of a training sequence, the receiver 320 determines the total phase distortion. Then, the receiver modifies the despreading waveform 301 in such a way that the output of the VCO 223 compensates approximately for the measured phase distortion.

Frequency Subdivision

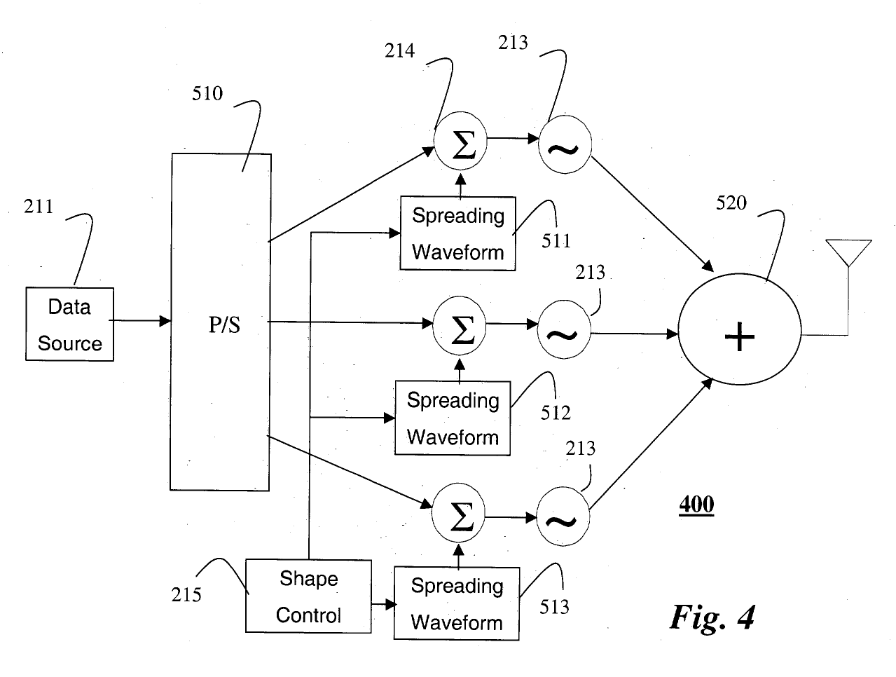

As shown in FIG. 4, it is also possible to convert the data stream into N substreams at a transmitter 400 using serial-to-parallel conversion 510.

Then, each substream is spread with respective different spreading waveform 511-513, fed to multiple VCOs 213, and combined 520 before transmitting as different transmitted signals. The VCOs can have non-overlapping (disjoint) output frequencies at all times, which enables the use of narrower-bandwidth VCOs. If the frequencies produced by the VCOs are overlapping, then the spreading waveforms are selected in such a way that any two VCOs never output signals in the same frequency range simultaneously at any one time. In a delay-dispersive channel, it must be assured that the frequencies of the RECEIVED signals corresponding to the different data substreams do not overlap.

Delayed Symbol Detection

If the channel is frequency selective, then it is possible that symbols of the transmitted signal are delayed or echoed. In other words, the total energy of the symbols can be spread over time. Therefore, it is desired to collect all of the energy in each symbol in order to maximize the signal to noise ratio.

Therefore, at a receiver 500, the received signal can be distributed to one or more different detector branches 601-603 using a parallel-to-serial converter 610. If the system uses frequency subdivision as described above, then there is one branch for each frequency subdivision. In the basic implementation, a single branch is used, and the P/S converter is not required.

Each detector branch has multiple VCOs 223. The first VCO stays on the transmit frequency for the duration of the first two symbols, or more, depending on the number of VCOs per branch. This ensures that all the energy transmitted by a “modulated pulse,” i.e., a rectangular signal with a carrier frequency corresponding to the transmit VCO frequency, is collected, even though the channel dispersed the signal over time due to delays and echoes.

If the maximum excess delay of the channel is smaller than a symbol length, then staying on the desired frequency for two symbol durations is sufficient to collect all of the signal energy. The next symbol transmitted in this branch is received by the second VCO, using the delay 620. The second VCO stays on that symbol for two symbol durations. The third symbol is received by the first VCO again, and so on. The detected signals are then combined by a parallel-to-serial converter 610 for the data sink 221.

It should be understood that a larger number of parallel structures can feed into the detector 225 if the delay is greater than two symbols periods.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for signaling in an ultra wide bandwidth communications system, comprising;
generating a spreading waveform in a transmitter;
shaping the spreading waveform according to shape data;
combining the shaped spreading waveform with source data into a combined signal; and
modulating the combined signal into a transmitted signal to shape a spectrum of the transmitted signal.

2. The method of claim 1 wherein the shape data include frequency ranges.

3. The method of claim 2 wherein the frequency ranges include desirable frequency ranges and undesirable frequency ranges.

4. The method of claim 2 wherein the frequency ranges are predetermined.

5. The method of claim 2 further comprising:
measuring the frequency ranges in a receiver; and
feeding back the frequency ranges to the transmitter in shape control messages.

6. The method of claim 5 wherein the measuring is instantaneous.

7. The method of claim 5 wherein the measuring is averaged over a time period.

8. The method of claim 5 wherein the transmitter and receiver are arranged as a transceiver.

9. The method of claim 3 further comprising:
transmitting a sounding signal;
measuring a channel transfer function from the sounding signal in a receiver to determine the undesirable frequency ranges.

10. The method of claim 7 wherein the channel transfer function of the undesirable frequencies has a low absolute magnitude.

11. The method of claim 1 further comprising:
measuring a signal to noise ration of the transmitted signal to determine the shape data.

12. The method of claim 1 further comprising:
measuring a signal to noise ration of a training sequence to determine the shape data.

13. The method of claim 1 further comprising:
receiving the transmitted signal in a receiver as a received signal;
equalizing the received signal to have a constant amplitude envelope;
generating a despreading waveform for the received signal to compensate for a phase distortion in the received signal, the despreading waveform being different than the spreading waveform.

14. The method of claim 13 further comprising:
measuring the phase distortion in a training sequence received in the receiver.

15. The method of claim 1 further comprising:
converting the source data into a plurality of substreams;
generating a different spreading waveform for each substream;
shaping each different spreading waveform according to the shape data;
combining each shaped different spreading waveform with each substream into a different combined signal; and
modulating each different combined signal into a different transmitted signal.

16. The method of claim 15 wherein frequencies of the different transmitted signals are disjoint at all times.

17. The method of claim 16 wherein the frequencies of the different transmitted signals are disjoint at any one time.

18. The method of claim 1 wherein the transmitted signal includes a plurality of symbols, and further comprising:
receiving each symbol in a receiver;
receiving one or more delayed copies of each symbol in the receiver; and
detecting the symbol from the received symbol and the delayed copies of each symbol.

19. The method of claim 1 further comprising:
converting the source data into a plurality of substreams;
generating a different spreading waveform for each substream;
shaping each different spreading waveform according to the shape data;
combining each shaped different spreading waveform with each substream into a different combined signal; and
modulating each different combined signal into a different transmitted signal, each different transmitted symbol including a plurality of symbols;
receiving, for each different transmitted signal, each symbol in a receiver;
receiving, for each transmitted signal, one or more delayed copies of each symbol in the receiver; and
detecting, for each transmitted signal, the transmitted symbol from the received symbol and the delayed copies of each symbol.

20. The method of claim 19 further comprising:
combining the detected symbols.
